(19) United States
(12) Patent Application Publication
(10) Pub. No.: US 2009/0004616 A1
(43) Pub. Date: Jan. 1, 2009

(54) CONSTRUCTIVE DISPOSITION INTRODUCED IN SUPPORTING PIECES FOR ORTHODONTIC ELASTIC RINGS

(75) Inventor: Oraci Joao de Vechi Morelli, Sorocaba (BR)

Correspondence Address: SMITH HOPEN, PA, 180 PINE AVENUE NORTH, OLDSMAR, FL, 34677, US

(73) Assignee: DENTAL MORELLI LTDA., Sorocaba (BR)

(21) Appl. No.: 12/145,780

(22) Filed: Jun. 25, 2008

(30) Foreign Application Priority Data
Jun. 26, 2007 (BR) BR8701096-8

(51) Int. Cl. A61C 3/00

(52) U.S. Cl. 433/3

(57) ABSTRACT

A constructive disposition introduced in supporting pieces for orthodontic elastics such that the present invention is related with a stem (1) of those types used by professionals in the orthodontic field to house elastics (E) in ligatures and other purposes. Said stem (1) is a metallic piece with a thickness that is compatible to maintain its rigidity and it may be provided with varied section. The stem (1) is provided with a flatted finishing (2a) in at least one of its ends (2d), thus forming a tab (2b) so as not to allow the elastics (E) to slip out of place. The stem ends (2d) are robust and round shaped, thus preventing accidents like glove perforations and other inconveniences.

### CROSS-REFERENCE TO RELATED APPLICATIONS

This application claims the benefit of priority of Brazilian Provisional Application No. BR8701096-8, filed Jun. 26, 2007 by the same inventor.

### FIELD OF INVENTION

The present utility model invention is related to a new constructive disposition introduced in supporting pieces for orthodontic elastic rings which is particularly used to carry, to store and to maintain the levels of memory in the elastic rings, thus facilitating the professional's work when he/she is performing the application of said elastic rings in the ligatures.

### BACKGROUND OF THE INVENTION

In a general considered manner, it is found that the present supporting pieces of orthodontic elastic rings, widely known as “laminated sticks”, disclose innumerous inconveniences for those professionals in the orthodontics area, particularly those in the orthodontic work when they are handling such supporting pieces in the moment of using the elastic rings at the time the metallic wire for corrective action is being inserted.

A brief study of the prior art discloses that in a conventional manner a thin supporting piece is used, this supporting piece illustrated in FIG. 1 as a way of better observation, such supporting piece being comprised of a metallic piece (named H), generally a circular shaped section that mostly is made of a central folding (named H1), thus emboding two stems named as h1 and h2. The stem end named h1 is clear finished whilst the stem end named h2 is provided with a circular folding resembling an eye H2 whose dimension is featured so as to hold the fingers of a professional person, thus assisting in handling the supporting piece and the elastic rings.

The elastic rings (E) are fitted in the thin supporting piece through a central folding (H1) in such a way to wrap the metallic stems (h1) and (h2). In order to avoid the elastic rings to escape from the supporting piece in a general manner said elastic rings are provided with a point ligature (L) thus resulting in a long strip of rings tied to one another and by the moment of being used such ligature is broken out.

Thus, one of the inconveniences of the conventional supporting piece is found in the fact that it is provided with a pair of stems that are too thin and not having an adequate hard shape to be manipulated. Another inconvenience is found in the fact that the elastic rings are tied one to another in such a way to difficult the withdrawal of one ring at one time and such an action of withdrawing the ring being generally carried out by a device named tying lace applicator. Furthermore, this physical ligature amongst the rings generates a fragility point when ligature is broken, thus endangering the ligature from being executed.

Another inconvenience is the fact that the stems ends (named h1 and h2) are sharply pointed out in a way to allow perforation in the gloves that are used by the professional staff during examination, either exposing the medical doctor or the patient to contamination.

Still another inconvenience is raised from the present configuration of the supporting pieces in relation to the eye shaped end (H2) once it is usual that they twist into one another inside the packages, not only occupying a larger room inside but also making it difficult of being picked out by the professional at work.

### SUMMARY OF INVENTION

Thinking about finding a solution to the aforesaid inconveniences, the present patent applicant developed a new constructive disposition introduced in the supporting pieces for orthodontic elastic rings aimed at eliminating the deficiencies mentioned in the prior art.

The supporting pieces now innovated comprise a rigid metallic stem with a compatible thickness in order to maintain the rigidity in said supporting pieces that also may have varied sections. The stem is provided with, at least in one of its ends, a double flatted area that configures a lateral thickness that avoids the elastic rings to slip out of place. The stem ends are robust and round thus preventing the gloves of being perforated and avoiding contamination and other inconveniences.

Another advantage in the present stem model is the fact that both ends are clear finished, that is, are not provided with an eye shaped folding, thus facilitating the withdrawal of the rings with the traditional tying lace applicator, thus simplifying at last the handling of elastic rings.

As a result from the features of the stem the elastic rings may be manufactured individually, that is, without any ligature to one another, in a way to facilitate the withdrawal of any individual ring thus preventing deformations that are generated in the time they are set apart from one another and by doing so they are kept in good order thus maintaining the levels of memory in the elastic ring.

Another quality added to the stem is the fact that the stem can be re-used in the manufacture of an appliance for functional orthopedics, a similar application for manufacture also in relation with the hard elastic wire or in relation with the semicircular end wire, thus increasing added value to the innovated stems and contributing to the environment.

### BRIEF DESCRIPTION OF THE DRAWINGS

In order to complement the present patent specification so as to obtain a better understanding of the features in the utility model invention and in accordance with a preferred practical embodiment of the invention a set of drawings is accompanied with this specification wherein in an exemplified but not limiting manner it is illustrated the following:

FIG. 1 is a perspective view of the stem and elastic rings that are found in the prior art.

FIG. 2 represents the view of a package containing multiple innovated stems and in a circled outlined manner an exploded perspective view of a stem provided with flatted finishing in the stem ends and provided with elastic rings in accordance with the proposed innovations.

FIG. 3 shows a detail of an end with flatted stem with the elastic rings.

FIG. 4 discloses cuts A.A and B.B in the stem in accordance with a preferred section.

FIG. 5 represents varied transverse cuts showing possible configurations in the profiles of the stem.

FIGS. 6 and 6A illustrate views in perspective of constructive variations in the supporting pieces.

FIG. 7 illustrates a possible application of the stem after its main use in which the discarded stem is directed to and applied in the manufacture of appliances for functional orthopedics.

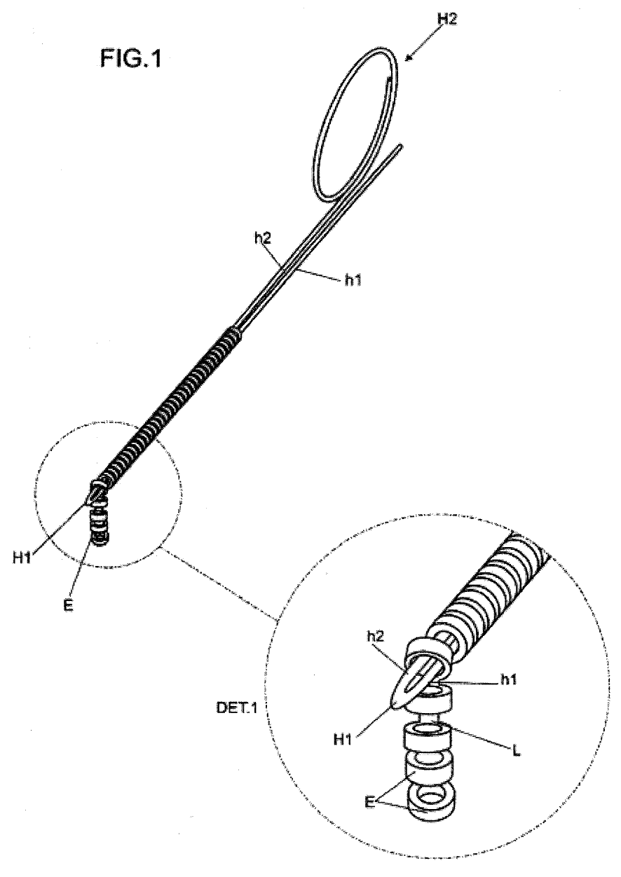

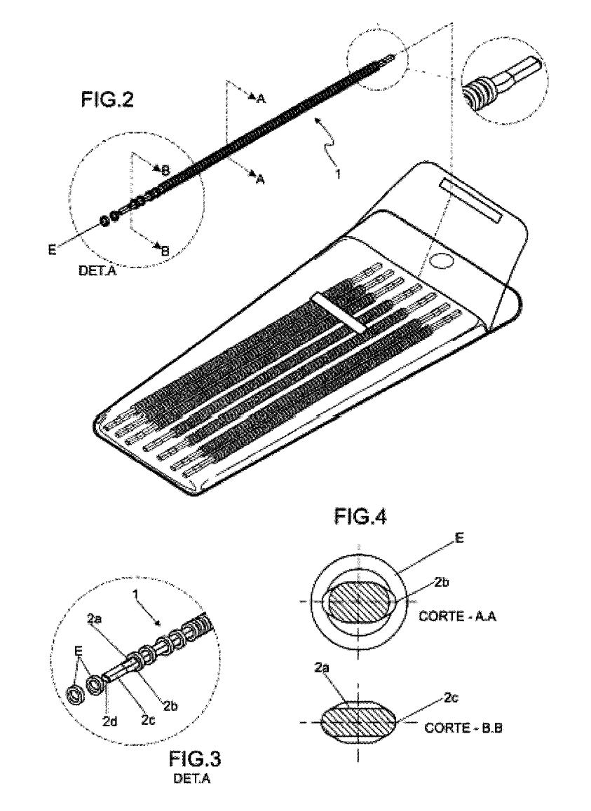

### DETAILED DESCRIPTION OF THE PREFERRED EMBODIMENT

With reference to the illustrated drawings the present invention is related to a new constructive disposition introduced in supporting pieces for orthodontic elastic rings, such supporting pieces used by professionals in the orthodontic area for the insertion of elastic rings (E) in ligatures and other purposes. Said supporting pieces comprise a rigid metallic stem (1), preferentially with an oblong section (details A.A and B.B) provided with at least one of its ends with a flatted finishing (2a) forming tabs (2b) that are aimed at preventing the elastic rings (E) from slipping out of place. The sides (2c) of stem (2) are round shaped and the stem ends (2d) are, in a preferred manner, clear finished.

Said stem (1) can be provided with various profiles, including being able of having a V shaped format (4), shaped in a semicircle (4a) and further in a configuration of round sides (4b) with a central area with upper and lower straight surfaces (4c).

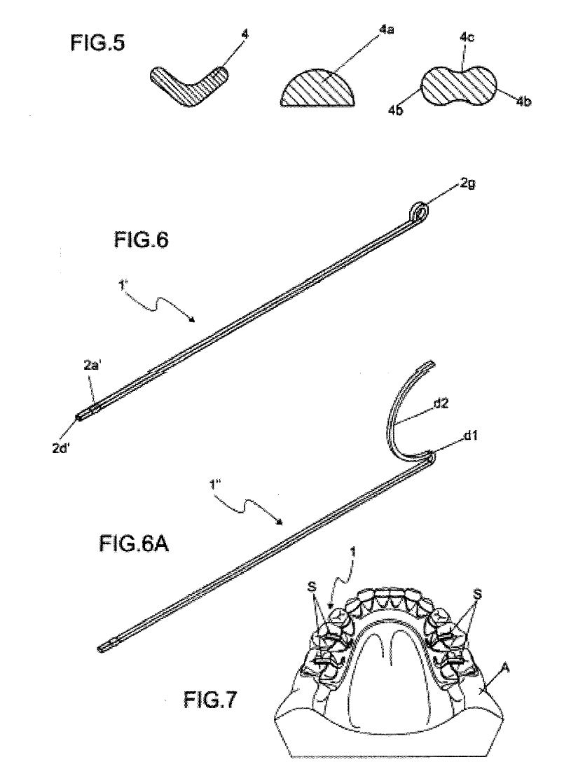

In a first constructive variation (FIG. 6) the stem (1′) is provided with a clear finished end (2d′) with a flatted finishing (2a′) whilst the other end will hold a folded ringed finishing (2g), thus serving as sliding barrier in relation with the elastic rings and also preventing the professional's gloves from being perforated.

In a second constructive embodiment (FIG. 6A) the stem (1″) is provided with a folded finishing (d1) followed by an ample semicircular curving (d2) in a way to form a sliding barrier for the elastic rings and a housing for supporting the professional's finger.

In another possible application for the stem (1) (FIG. 7) it can be divided in segments (S) forming portions of stem to be used in the manufacture of appliances for functional orthopedics (A) and other applications.

Whilst the preferred embodiments of the present invention are disclosed, any and all changes and/or alterations should be understood as falling within the scope of the present invention, perfectly meeting the criteria that defines such a scope, that is, a combination and modification of elements that are already known in a new form or disposition thus having as a result the functional improvement in its use and as well its manufacturing process.

Now that the invention has been described,

What is claimed is:

1. A constructive disposition introduced in supporting pieces for orthodontic elastics, such supporting pieces of a type used by professionals in the orthodontic field for the application of elastics (E) for the purposes of ligature and other purposes, characterized in that it is comprised of a metallic rigid stem (1), such a stem provided with a flatted finishing (2a) in at least one of its ends, thus forming tabs (2b); the lateral sides (2c) of the stem (1) are round shaped and its ends (2d) are, preferably, clear finished.

2. A constructive disposition introduced in supporting pieces for orthodontic elastics in accordance with claim 1 and in a preferred constructive embodiment characterized in that the stem (1) is provided with a flatted finishing (2a) in the two ends.

3. A constructive disposition introduced in supporting pieces for orthodontic elastics in accordance with claim 1 and in a preferred embodiment characterized in that the stem (1) is provided with an oblong section.

4. A constructive disposition introduced in supporting pieces for orthodontic elastics in accordance with claim 1 and in a constructive embodiment characterized in that the stem (1) is provided with a V shaped section (4).

5. A constructive disposition introduced in supporting pieces for orthodontic elastics in accordance with claim 1 and in another constructive embodiment characterized in that the stem (1) is provided with a semicircular section (4a).

6. A constructive disposition introduced in supporting pieces for orthodontic elastics in accordance with claim 1 and in still another constructive embodiment characterized in that the stem (1) is formed with round lateral sides (4b) and as well provided with a central area with upper and lower straight surfaces (4a).

7. A constructive disposition introduced in supporting pieces for orthodontic elastics in accordance with the previous claims characterized in that the stem (1) is provided with a clear finished end (2d′), such clear end provided with a flatted finishing (2a′) whilst the other end is provided with a folded ring finishing (2g).

8. A constructive disposition introduced in supporting pieces for orthodontic elastics in accordance with the previous claims 1-7 characterized in that the stem (1) is provided with a folding (d1) followed by an ample semicircular curving (d2) thus forming a tab.
